(19) United States
(12) Patent Application Publication
(10) Pub. No.: US 2022/0055194 A1
(43) Pub. Date: Feb. 24, 2022

(54) Electric Staple Punch

(71) Applicant: James Reynolds, Plymouth, MA (US)

(72) Inventor: James Reynolds, Plymouth, MA (US)

(21) Appl. No.: 17/334,164

(22) Filed: May 28, 2021

Related U.S. Application Data
(60) Provisional application No. 63/067,026, filed on Aug. 18, 2020.

(51) Int. Cl. B25C 5/11; B25C 5/16

(52) U.S. Cl. CPC B25C 5/11; B25C 5/1637

(57) ABSTRACT

A fastener driver apparatus suitable for guiding and driving electrical staples into timber or on any other suitable mounting surface is presented. The fastener driver contains a driver body, a driver rod, and a fastener guide. The driver body contains a first driver channel and a mounting end. The mounting end is positioned adjacent to the driver body. The first driver channel traverses through the driver body and the mounting end. The driver rod is slidably connected to the driver body. The fastener guide is connected adjacent to the mounting end.

The current application claims a priority to the U.S. Provisional Patent application Ser. No. 63/067,026 filed on Aug. 18, 2020.

### FIELD OF THE INVENTION

The present invention generally relates to a punch device. More specifically, the present invention relates to a punch device for staples, including electrical staples.

### BACKGROUND OF THE INVENTION

A device for punching staples is in demand. People use staples for many things, including construction and affixing papers to bulletin boards. Staples can be used to hold wires, with some staples having an insulation coating or plastic strip attached to help protect such wires.

Modern staples are bent metal fasteners that can be punched in using a staple gun or staple hammer. A staple gun, a tool designed to drive metal staples into various kinds of materials, can be used to fasten materials onto masonry, plastic, and wood. A staple gun is a quicker, more powerful version of the office stapler. Generally, staples can be more convenient than nails to use in fastening items, but various issues can be encountered when using staplers or staple guns.

Sometimes a staple gun can dispense a few staples at the same time, causing a bad attachment that requires repair time. This can be a very discouraging problem, especially for people who need to complete a project on a deadline. Sometimes a staple gun may be received defective from the manufacturer, so that its trigger is very hard to pull, requiring considerable pressure to punch in a staple. What's more, most staple guns are heavy and bulky, so that users may have difficulty reaching or properly aiming at some areas with the gun. Thus, there is a need to develop a device that solves these problems.

The present invention is intended to address problems associated with and/or otherwise improve on conventional devices through an innovative punch device that is designed to provide a convenient means of punching in staples while incorporating other problem-solving features.

### SUMMARY OF THE INVENTION

The present invention is a fastener driver apparatus suitable for guiding and driving electrical staples into timber or on any other suitable mounting surface. The fastener driver comprises a driver body, a driver rod, and a fastener guide. The driver body comprises a first driver channel and a mounting end. The mounting end is positioned adjacent to the driver body. The first driver channel traverses through the driver body and the mounting end. The driver rod is slidably connected to the driver body. The fastener guide is connected adjacent to the mounting end.

### BRIEF DESCRIPTION OF THE DRAWINGS

FIG. 1 is a top perspective view of the present invention.

FIG. 2 is a top view of the present invention.

FIG. 3 is a cross-sectional view taken along cutting line A-A in FIG. 2.

FIG. 4 is an exploded view of the present invention.

FIG. 5 is a top exploded view of the present invention.

FIG. 6 is a cross-sectional view taken along cutting line B-B in FIG. 5.

FIG. 7 is a top perspective view of the present invention in accordance with another embodiment.

### DETAIL DESCRIPTIONS OF THE INVENTION

All illustrations of the drawings are for the purpose of describing selected versions of the present invention and are not intended to limit the scope of the present invention. The present invention is to be described in detail and is provided in a manner that establishes a thorough understanding of the present invention. There may be aspects of the present invention that may be practiced or utilized without the implementation of some features as they are described. It should be understood that some details have not been described in detail in order to not unnecessarily obscure focus of the invention. References herein to “the preferred embodiment”, “one embodiment”, “some embodiments”, or “alternative embodiments” should be considered to be illustrating aspects of the present invention that may potentially vary in some instances, and should not be considered to be limiting to the scope of the present invention as a whole.

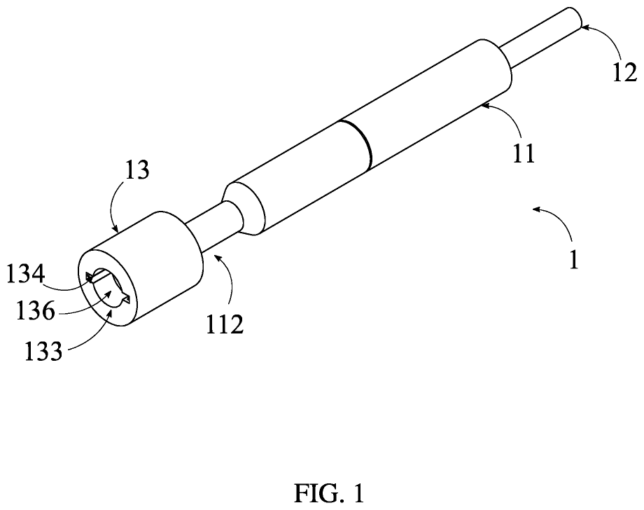

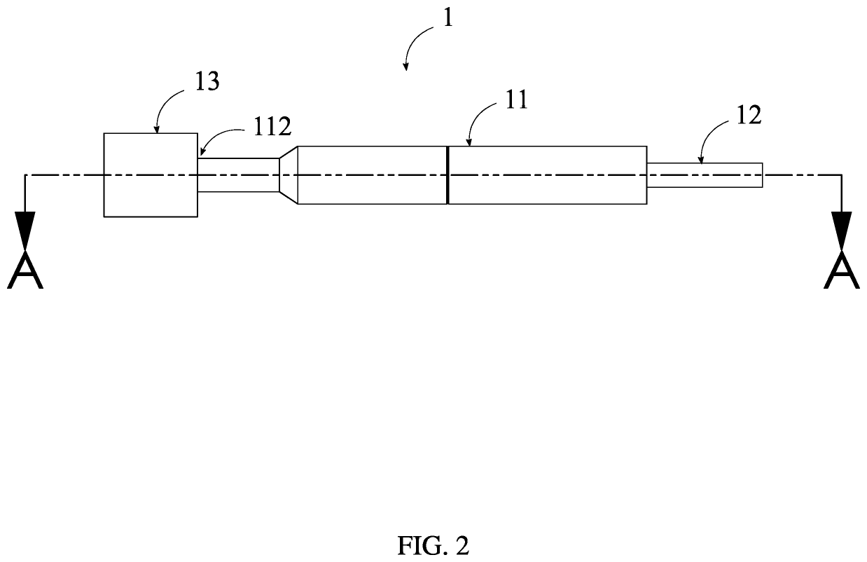

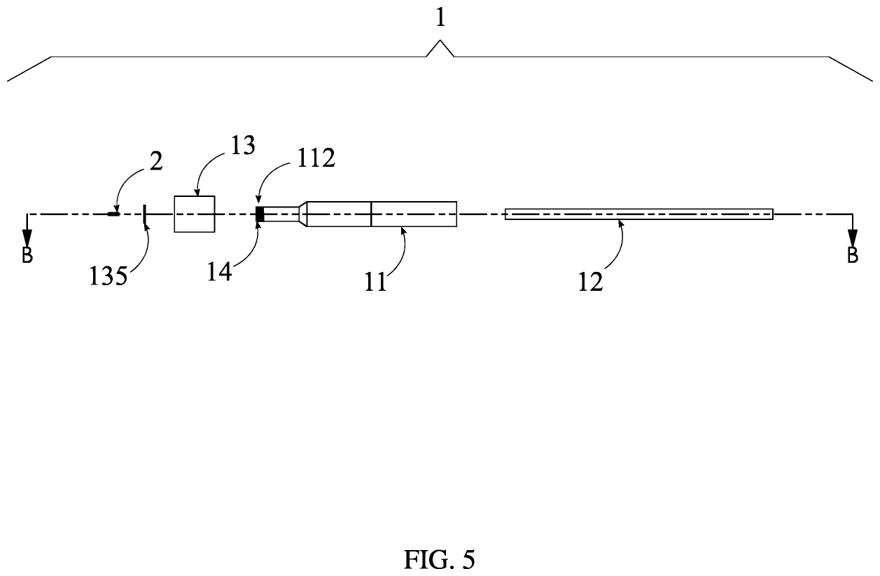

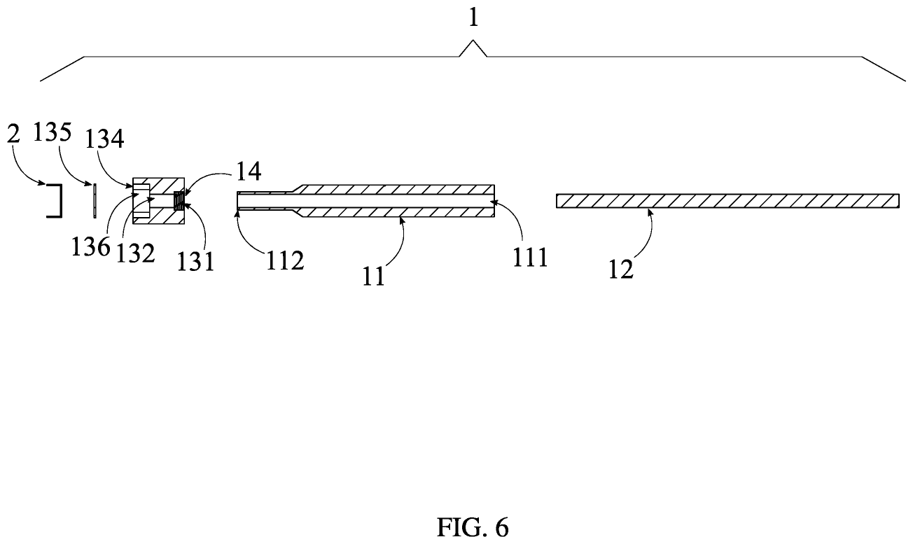

In reference to FIGS. 1-6, the present invention is a fastener driver apparatus 1 suitable for guiding and driving electrical staples into timber or on any other suitable mounting surface. The fastener driver apparatus 1 comprises a driver body 11, a driver rod 12, and a fastener guide 13. The driver body 11 comprises a first driver channel 111 and a mounting end 112. The mounting end 112 is positioned adjacent to the driver body 11, as shown in FIGS. 1-6. The first driver channel 111 traverses through the driver body 11 and the mounting end 112, as shown in FIG. 6. The driver rod 12 is slidably connected to the driver body 11. The fastener guide 13 is connected adjacent to the mounting end 112, as shown in FIGS. 1-6. In the preferred embodiment of the present invention, the driver body 11 is made out of a durable material, such as, but not limited to steel, aluminum, polymer, or any other suitable material. In the preferred embodiment of the present invention, the driver rod 12 is made out of a durable material capable of withstanding impact blows from a hammer, such as, but not limited to steel. The fastener guide 13 secures and holds a fastener 2 along the driver body 11, such that the fastener 2 is aligned to the driver rod 12. This allows a user to positioned and orient the fastener 2 along a desired object to be fastened. This object may take the form of an electrical cable, trim panels, or any other applicable object. Once the fastener 2 is positioned, the user may strike the driver rod 12 with a driving device to drive the driver rod 12 along the fastener guide 13, mounting the fastener 2 to the desired object to a suitable mounting surface. In the preferred embodiment of the present invention, the fastener guide 13 is made out of a material that produces a magnetic field. This allows magnetic fasteners 2 to magnetically mount along the fastener guide 13.

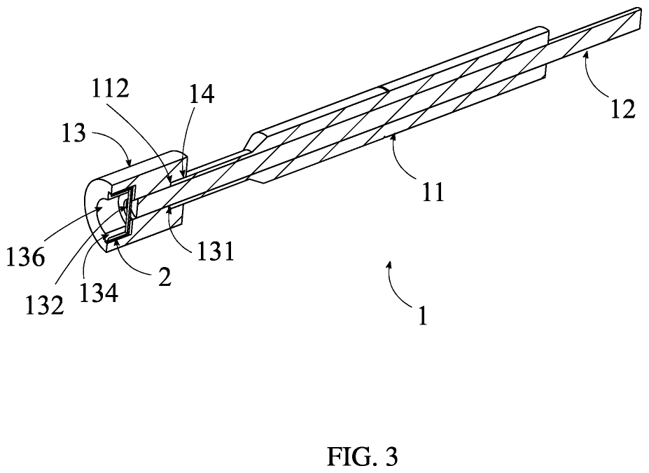

In reference to FIGS. 1 and 3-6, the fastener guide 13 comprises a mounting aperture 131, a second driver channel 132, and a fastener holder 133. The mounting aperture 131 and the fastener holder 133 are positioned terminally opposite to each other along the fastener guide 13. The second driver channel 132 traverses from the mounting aperture 131 to the fastener holder 133. The mounting aperture 131 is removably attached to the mounting end 112 through a fastening element 14, as shown in FIGS. 3-6. In various embodiments, the fastener holder 133 may take the form of various holder implements suitable for holding a fastener 2, such as, but not limited to staple holders, nail holders, tack holders, or any other suitable holder. In the preferred embodiment of the present invention, the fastener guide 13 is interchangeable, allowing the user to swap the fastener guide 13 to accommodate for different types of fasteners 2. In the preferred embodiment of the present invention, the fastening element 14 may take the form of a threaded fastening element 14 but may take the form of any other fastening element 14, such as, but not limited to locking lugs, detent connectors, or any other suitable type of fastening element 14.

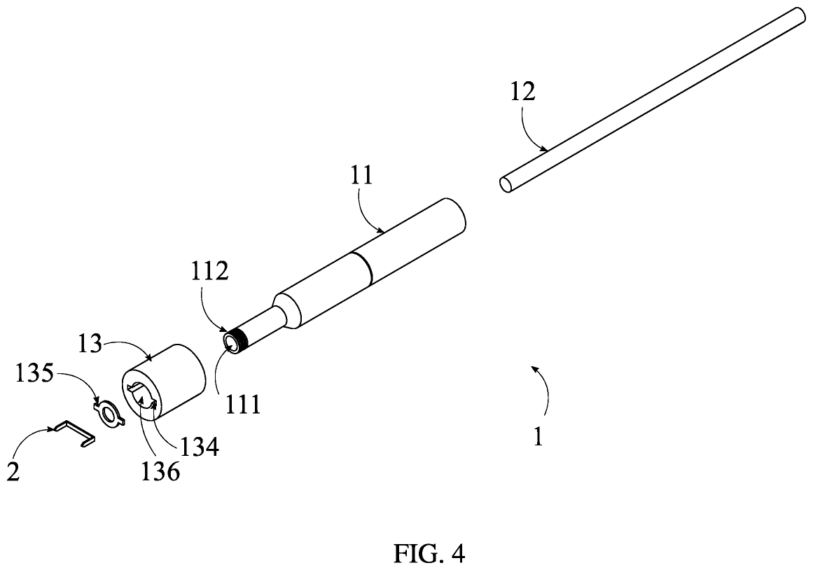

In another embodiment, the fastener guide 13 comprises a mounting aperture 131, a second driver channel 132, a fastener channel 134, and a mounting element 135. The mounting aperture 131 and the fastener channel 134 are positioned terminally opposite to each other along the fastener guide 13. The second driver channel 132 traverses from the mounting aperture 131 to the fastener holder 133. The mounting element 135 is connected adjacent to the fastener channel 134. In the preferred embodiment of the present invention, the fastener channel 134 stores and guides the fastener 2 within the fastener guide 13. The mounting element 135 is a magnet insert that holds and secures the fastener 2 within the fastener guide 13, as shown in FIG. 4-6.

In another embodiment, the fastener guide 13 comprises a mounting aperture 131, a second driver channel 132, a fastener channel 134, a fastener aperture 136, and a mounting element 135. The mounting aperture 131 and the fastener channel 134 are positioned terminally opposite to each other along the fastener guide 13. The fastener aperture 136 traverses through the fastener channel 134, as shown in FIGS. 1, 3, 4, and 6. The second driver channel 132 traverses from the mounting aperture 131 to the fastener holder 133. The mounting element 135 is a magnet insert that holds and secures the fastener 2 within the fastener guide 13. The mounting element 135 is connected adjacent to the fastener channel 134 and the fastener aperture 136. In this embodiment, the fastener aperture 136 accommodates a different type of fastener 2, where the fastener channel 134 is configured to hold and store an electric staple and the fastener aperture 136 is configured to hold and store a nail, electric staple insulator, or any other type of fastener implement.

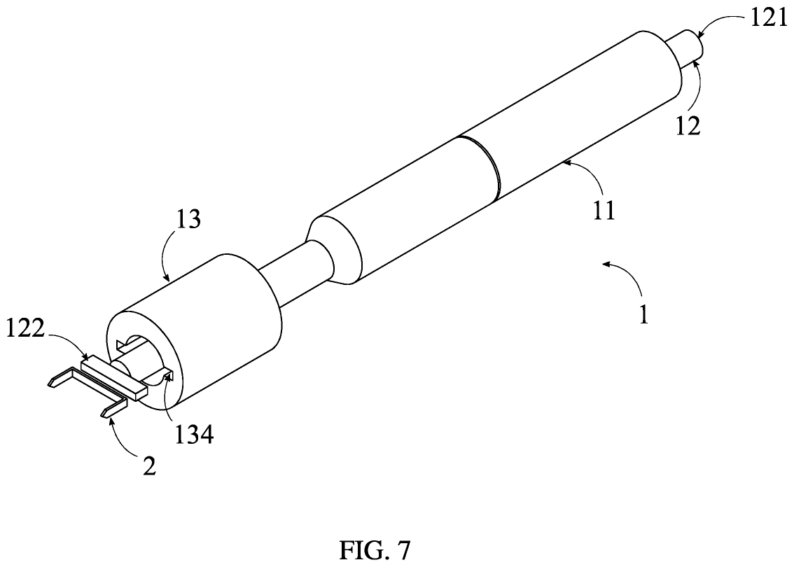

In another embodiment, the driver rod 12 comprises a striking end 121 and an impact element 122, as shown in FIG. 7. The striking end 121 and the impact element 122 are terminally positioned opposite to each other along the driver rod 12. The impact element 122 is slidably connected to the fastener channel 134. The impact element 122 serves as an impact buffer that conforms to an optimal impact surface for the fastener 2.

This prevents the fastener 2 from damage or deformation when the driver rod 12 is driving the fastener 2 along the fastener channel 134. In the preferred embodiment of the present invention, the impact element 122 is made out of a material that produces a magnetic field. This allows magnetic fasteners 2 to magnetically mount along the impact element 122.

Although the invention has been explained in relation to its preferred embodiment, it is to be understood that many other possible modifications and variations can be made without departing from the spirit and scope of the invention as hereinafter claimed.

What is claimed is:

1. A fastener driver apparatus comprising:
a driver body;
a driver rod;
a fastener guide;
the driver body comprising a first driver channel and a mounting end;
the mounting end being positioned adjacent to the driver body;
the first driver channel traversing through the driver body and the mounting end;
the driver rod being slidably connected to the driver body; and
the fastener guide being connected adjacent to the mounting end.

2. The fastener driver apparatus as claimed in claim 1 comprising:
the fastener guide comprising a mounting aperture, a second driver channel, and a fastener holder;
the mounting aperture and the fastener holder being positioned terminally opposite to each other along the fastener guide;
the second driver channel traversing from the mounting aperture to the fastener holder; and
the mounting aperture being removably attached to the mounting end through a fastening element.

3. The fastener driver apparatus as claimed in claim 1 comprising:
the fastener guide comprising a mounting aperture, a second driver channel, a fastener channel, and a mounting element;
the mounting aperture and the fastener channel being positioned terminally opposite to each other along the fastener guide;
the second driver channel traversing from the mounting aperture to the fastener holder; and
the mounting element being connected adjacent to the fastener channel.

4. The fastener driver apparatus as claimed in claim 1 comprising:
the fastener guide comprising a mounting aperture, a second driver channel, a fastener channel, a fastener aperture, and a mounting element;
the mounting aperture and the fastener channel being positioned terminally opposite to each other along the fastener guide;
the fastener aperture traversing through the fastener channel;
the second driver channel traversing from the mounting aperture to the fastener holder; and
the mounting element being connected adjacent to the fastener channel and the fastener aperture.

5. The fastener driver apparatus as claimed in claim 1, wherein the fastener guide is made out of a material that produces a magnetic field.

6. The fastener driver apparatus as claimed in claim 3, wherein the mounting element is a magnet insert.

7. The fastener driver apparatus as claimed in claim 4, wherein the mounting element is a magnet insert.

8. The fastener driver apparatus as claimed in claim 3 comprising:
the driver rod comprising a striking end and an impact element;
the striking end and the impact element being terminally positioned opposite to each other along the driver rod; and
the impact element being slidably connected to the fastener channel.

9. The fastener driver apparatus as claimed in claim 8, wherein the impact element is made out of a material that produces a magnetic field.
